(19) United States
(12) Patent Application Publication
(10) Pub. No.: US 2007/0202930 A1
(43) Pub. Date: Aug. 30, 2007

(54) Method and system for testing embedded echo canceller in wireless network

(75) Inventors: Binshi Cao, Bridgewater, NJ (US); Doh-Suk Kim, Basking Ridge, NJ (US); Amanuel Zerzghi, Bridgewater, NJ (US)

Correspondence Address: MCCORMICK, PAULDING & HUBER LLP, 185 ASYLUM STREET, CITY PLACE II, HARTFORD, CT, 06103, US

(73) Assignee: Lucent Technologies Inc., Murray Hill, NJ (US)

(21) Appl. No.: 11/363,108

(22) Filed: Feb. 27, 2006

(51) Int. Cl. H04M 9/08; H04B 1/38; H04M 1/00

(52) U.S. Cl. 455/570; 379/406.01

(57) ABSTRACT

An embedded echo canceller in a wireless network is tested by routing traffic signals through the echo canceller and measuring input and output signals of the echo canceller as it operates to remove echo signals from the traffic signals. To test the operation of the echo canceller in regards to a plurality of hybrid circuits, a hybrid interface box controlled by an echo canceller test program is attached to an upstream end of the echo canceller. An ISUP communication is established between two wireless units, through the echo canceller and a loop around trunk. The communication is traced, and a traffic channel portion of the communication (separate from a signaling channel) is broken. Because the two channels are separate under ISUP, this does not terminate the communication. The hybrid interface box is controlled to inject test signals into the traffic channel, and the operation of the echo canceller is measured.

### FIELD OF THE INVENTION

The present invention relates to wireless communications and, more particularly, to echo cancellers in wireless communication systems.

### BACKGROUND OF THE INVENTION

In telephony communication systems, e.g., wireless communication networks and public switched telephone networks (“PSTN”), undesired echo is electronically controlled to maintain acceptable quality of service levels. Echo occurs when a portion of the signals input into a communication device are “reflected” or otherwise transferred back to the user above user-perceivable thresholds. For example, unless echo is controlled, a user talking on a mobile phone may hear his own voice a short time after speaking into the handset, literally creating an echo effect. The typical sources of echo are shown in FIG. 1. There, a communication network 10 (shown in. simplified form) includes a wireless network 12 and a PSTN 14. The wireless network 12 may be, for example, a CDMA-based network, and includes a radio network controller and/or mobile switching center (“MSC”) 16 connected to one or more fixed base stations 18. The base station 18 includes a base station controller 20 and various transceivers and antennae 22 for radio communications with a plurality of distributed wireless units 24. (Only one wireless unit is shown.) The wireless units 24 may include, for example, mobile phones, wireless PDA's, wireless devices with high-speed data transfer capabilities, such as those compliant with “3-G” or “4-G” standards, “WiFi”-equipped computer terminals, and the like. The MSC 16 interconnects the base stations and performs the signaling functions necessary to establish calls and other data transfer to and from the wireless units 24. It also acts as the interface between the wireless network 12 and the PSTN 14, which allows the wireless units 24 to access PSTN services such as originating and receiving PSTN calls, e.g., calls to public landline phones 26.

A first source of echo is acoustic echo. In acoustic echo, a wireless unit's microphone 28 picks up sound emanated by its speaker 30, both directly and from reflection off nearby surfaces, e.g., the interior of a vehicle. This may be especially problematic with “hands-free” wireless devices. Acoustic echo may also include and/or be exacerbated by ambient noise. A second type of echo is hybrid echo. Hybrid echo occurs in the PSTN 14 as a result of signal reflections in a hybrid circuit 32 (“hybrid”). A hybrid 32 is an electronic circuit or device used to convert a four-wire PSTN circuit to a two-wire PSTN circuit. The former is used for the core of the PSTN network, for connecting local exchanges and/or long distance transmission. The latter is used to connect a local exchange to a subscriber's premises. As voice signals 34 pass from the four-wire circuit to the two-wire circuit, a portion of the signal energy is effectively reflected back on itself, creating echoed speech 36. Signal propagation and processing delays may also contribute to echo.

To counteract echo, the communication network 10 will typically include one or more embedded echo cancellers 38 positioned in the digital portion of the circuit. The echo canceller 38 uses signal processing and filtering means to remove a large percentage of the echo. For example, in a typical system the echo canceller might employ a digital adaptive filter to set up a model or characterization of the voice signal and echo passing through the echo canceller. As a voice path passes back through the cancellation system, the echo canceller compares the signal and the model to cancel echo dynamically. A non-linear processor may also be used to eliminate any remaining echo by attenuating the signal below the noise floor. Wireless units may also be configured to help with the echo cancellation process, especially in the case of acoustic echo.

In designing and implementing an echo canceller for use in a communication network 10, testing is typically required for determining that the canceller functions in an intended manner within the context of the network. It may also be necessary to test whether the echo canceller meets one or more industry standards for operation within certain parameters. Testing of embedded echo cancellers is usually performed offline, with the processor algorithm being evaluated using computer executable simulations. However, the results of such testing may not be as extensive or accurate as desired, and may not allow for the testing of an echo canceller with respect to certain standards.

### SUMMARY OF THE INVENTION

An embodiment of the present invention relates to a method for testing an embedded echo canceller in a wireless network. By “embedded,” it is meant that the echo canceller is deployed in the network, e.g., at a mobile switching center or the like, for carrying out echo cancellation operations on data traffic signals (e.g., voice or other data signals) in the network. The data traffic signals are routed through the echo canceller. As the echo canceller operates on the traffic signals to remove echo signals, one or more input and/or output signals of the echo canceller are measured for gauging the performance of the echo canceller. The echo signals are introduced or caused by a hybrid unit. “Hybrid unit” refers to a hybrid circuit in a PSTN (public switched telephone network), a device for simulating the operation of a hybrid circuit, or the like. A hybrid circuit is an electronic device configured for interfacing one type of trunk line with another, e.g., a 4-wire trunk circuit and a 2-wire trunk circuit.

In another embodiment, the echo canceller is located between a radio access portion of the network and the hybrid unit. For example, the echo canceller may be deployed at a mobile switching center. Various input and output signals of the echo canceller are measured. On the upstream side of the echo canceller (by the hybrid unit), the input and output signals may be measured at a digital signal cross-connect panel (“DSX panel”) connected in parallel to the echo canceller and hybrid unit. On the downstream side of the echo canceller (on the side of the radio access portion of the network), the input and output signals of the echo canceller may be approximately measured by measuring the input and output signals at a radio access interface of the echo canceller. “Radio access interface” refers not to the direct inputs/outputs of the echo canceller, but to more easily accessible points of the signal path downstream of the echo canceller, such as a base station input/output, a mobile switching center input/output, or a vocoder input/output.

In another embodiment, the hybrid unit is a hybrid interface box connected to the upstream side of the echo canceller and controlled by an echo canceller test program. The hybrid interface box is an electronics device for simulating the operation of a hybrid circuit. In operation, the hybrid unit is controlled to generate the echo signals, which in this case are test signals simulating the operation of a hybrid circuit. The hybrid interface box and/or test program may be configured to simulate a number of different hybrid circuits, for testing the echo canceller for compliance with various standards such as G.168-2000.

In another embodiment, the hybrid interface box is initially connected to the upstream side of the echo canceller (directly or indirectly). Subsequently, an ISUP communication is established between two wireless units in such a manner that the communication is routed through the echo canceller and a loop around trunk. “ISUP” is the ISDN User Part, a communications protocol used to setup, manage, and release trunk circuits that carry voice and data between parties. The ISUP protocol specifies separate traffic and signaling/control channels, as opposed to using in-band signaling. Thus, the communication may be an ISUP communication or another type of communication having separate signaling and traffic channels. Generally speaking, a loop around trunk is a line/channel used to route a communication through the same switch. Here, the loop around trunk ensures that the communication is routed along a path allowing for access to the traffic channel portion of the communication. In particular, the communication is traced to identify at least the traffic channel portion of the communication. The traffic channel is then broken, and the hybrid interface box is controlled to inject test signals into the traffic channel, e.g., the test signals simulate a traffic signal and/or echo signal as relating to a type of hybrid circuit. Operation of the echo canceller is then gauged by measuring its input and output signals. The second mobile may be ignored. Because the traffic and signaling channels of the ISUP communication are separate, the traffic channel may be broken without terminating the communication.

### BRIEF DESCRIPTION OF THE DRAWINGS

The present invention will be better understood from reading the following description of non-limiting embodiments, with reference to the attached drawings, wherein below:

FIG. 1 is a schematic view of a communication network;

FIG. 2 is a schematic view of a system for testing an embedded echo canceller according to an embodiment of the present invention;

FIGS. 3 and 4 are schematic views of an additional embodiment of the system for testing an embedded echo canceller;

FIG. 5 is a schematic view showing a connection between a DSX panel and hybrid interface box portion of the system;

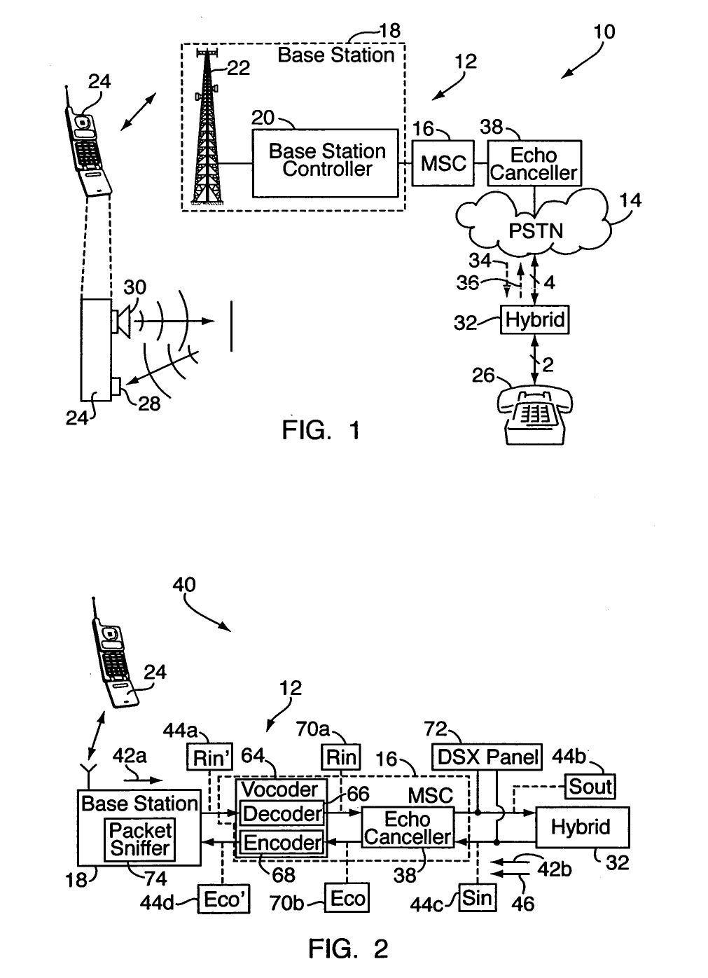

### DETAILED DESCRIPTION

With reference to FIGS. 2-5, a system 40 is used for testing an embedded echo canceller 38 in a wireless network 12. The network 12 may include one or more mobile switching centers (“MSC”) 16, various fixed base stations 18, and various distributed wireless units 24, in a manner as described above. The echo canceller will typically be deployed at the MSC 16 (e.g., operably interfaced with the MSC's circuitry and components in a standard manner) for carrying out ongoing echo cancellation operations on data traffic signals routed through the MSC 16. For testing the echo canceller 38, traffic signals 42a, 42b are first routed through the echo canceller. Then, the input and output signals 44a-44d of the echo canceller 38 are measured as the echo canceller operates to remove echo signals 46 from the traffic signals. The measured signals can be processed, interpreted, or otherwise used to gauge the echo canceller's performance in removing echo 46 introduced by a single hybrid circuit 32. To test the operation of the echo canceller 38 in regards to a plurality of hybrid circuits, but without having to remove the canceller or swap out hybrid circuits (which would be highly impracticable in most communication systems), a hybrid interface box 50 may be attached to an upstream end of the echo canceller 38. As further explained below, an ISUP communication 52 is established between two wireless units 54a, 54b through the echo canceller 38 and a loop around trunk 56. The communication 52 is traced, and a traffic channel portion 58 of the communication (separate from a signaling channel 60) is broken. Because the two channels 58, 60 are separate under the ISUP standard, this does not terminate the communication 52. The hybrid interface box 50 is controlled to inject test signals 62 into the traffic channel 58, and the operation of the echo canceller 38 is measured.

Referring back to FIG. 2, the echo canceller 38 is configured for carrying out echo cancellation operations on data traffic signals in the network 12. For this purpose, the echo canceller may be deployed at an MSC 16 or elsewhere in the network. For example, the echo canceller 38 may be positioned “upstream” of a vocoder unit 64 and “downstream” of the PSTN and hybrid unit 32. The vocoder 64 is a standard device used to convert analog sound signals to digitally encoded data and vice versa. Thus, the vocoder 64 may include a decoder portion 66 and an encoder portion 68. In operation, voice signals are encoded at the wireless unit 24 (e.g., the wireless unit also includes a vocoder), transmitted over the wireless/RF interface, and decoded by the vocoder 64 for further processing by the MSC 16. The vocoder may be located at the MSC 16 or at the base station 18, depending on the particular configuration of the network and the components therein.

Typically, the echo signals 46 will be hybrid echo signals introduced by a hybrid circuit 32. (The echo canceller may also be configured to remove acoustic echo.) As noted above, the hybrid 32 is an electronic circuit or device used to convert a four-wire circuit to a two-wire circuit, e.g., in a PSTN 14. When data traffic signals 42a (e.g., voice or other data signals) encounter the hybrid circuit 32, a portion of the signal energy passes through the hybrid 32 and on to a landline telephone 26 or the like. However, a portion of the signal energy may also be “reflected” to the output of the hybrid circuit 32 as an echo signal 46. The echo signal 46 mixes with whatever traffic signals 42b originate from the upstream side of the hybrid (e.g., voice signals from the telephone 26), if any. Stated simply, the echo canceller 38 compares the original upstream traffic signal 42a to the downstream combined signal 44c (“Sin”) output from the hybrid circuit 32. Since the traffic signal 42a and the echo signal 46 are related, the echo canceller uses the traffic signal 42a to identify the echo signal 46 and remove it from the combined signal 44c.

For testing the embedded echo canceller 38, traffic signals 42a, 42b are routed through the echo canceller. This may be done in a standard manner by specifically establishing a communication that passes through the echo canceller, e.g., a phone call from a wireless unit 24 to a landline phone 26 that includes signaling or setup parameters for routing through the echo canceller. Alternatively, the traffic signals may be signals not specifically intended for testing purposes, e.g., data transmissions between two third parties that coincidentally are routed through the echo canceller. As should be appreciated, an MSC 16 will typically include a number of echo cancellers and vocoders for assigning and re-assigning to different communications as the communications are established and terminated. Since the echo cancellers are all typically the same model, it may be sufficient to set up testing for one of the cancellers at random, and to then wait for traffic signals to pass through the echo canceller. (As further explained below, the communication may be traced to in effect identify the echo canceller through which the communication is passing.) Privacy provisions may need to be taken into consideration.

During the time when traffic signals 42a, 42b are routed through the echo canceller 38; the input and output signals 44a-44d of the echo canceller 38 are measured as the echo canceller operates to remove echo signals 46 from the traffic signals. At the upstream side of the echo canceller 38, the measured signals may include an upstream output 44b (“Sout”) of the echo canceller and the downstream input signal “Sin” 44c. As mentioned, the downstream input signal Sin 44c may include a traffic portion 42b and an echo portion 46. The Sin signal 44c and the Sout signal 44b can be measured in a standard manner using a PCM (pulse code modulation) analyzer, a VF (voice frequency) meter, or the like (not shown) at a DSX (digital signal cross-connect) panel 72 connected to or otherwise a part of the MSC 16 and/or echo canceller 38. The DSX panel 72 is a device that allows for the reconfigurable connection of one digital device or line to another. A typical DSX panel includes a large number of electrical ports, each of which can be connected to a line or device. The lines or devices are connected to one another by running jumpers or patch cables between the ports. To change connections, it is simply a matter of rerouting the jumpers or patch cables, instead of hardwiring the devices or lines to one another. Oftentimes, an MSC 16 will have a DSX panel 72 as part of its standard equipment for connecting or routing trunk lines (or other devices or lines) to the MSC 16.

On the downstream side of the echo canceller, there will typically be an upstream input signal 70a (“Rin”) and a downstream output signal 70b (“eco”), between the vocoder 64 and the echo canceller 38. However, it may not be possible to physically access these points in the MSC 16 for measuring the signals. Accordingly, it is possible to approximate the Rin signal 70a and the eco signal 70b by measuring input and output signals at a radio access interface of the echo canceller. As noted above, “radio access interface” refers not to the direct inputs/outputs of the echo canceller 70a, 70b, but to more easily accessible points of the signal path downstream of the echo canceller. For example, an upstream input signal 44a (“Rin′”) of the decoder 66 and a downstream output signal 44d (“Eco′”) of the encoder 68 may be measured in a standard manner using a voice packet sniffer 74 at the base station 18 or a similar tool at the packet pipe interface. The measured signals 44a-44d can be processed, interpreted, or otherwise used to gauge the echo canceller's performance in removing echo 46 introduced by a single hybrid circuit 32. In particular, the testing will be with respect to whatever type of hybrid circuit 32 is in place on the PSTN 14.

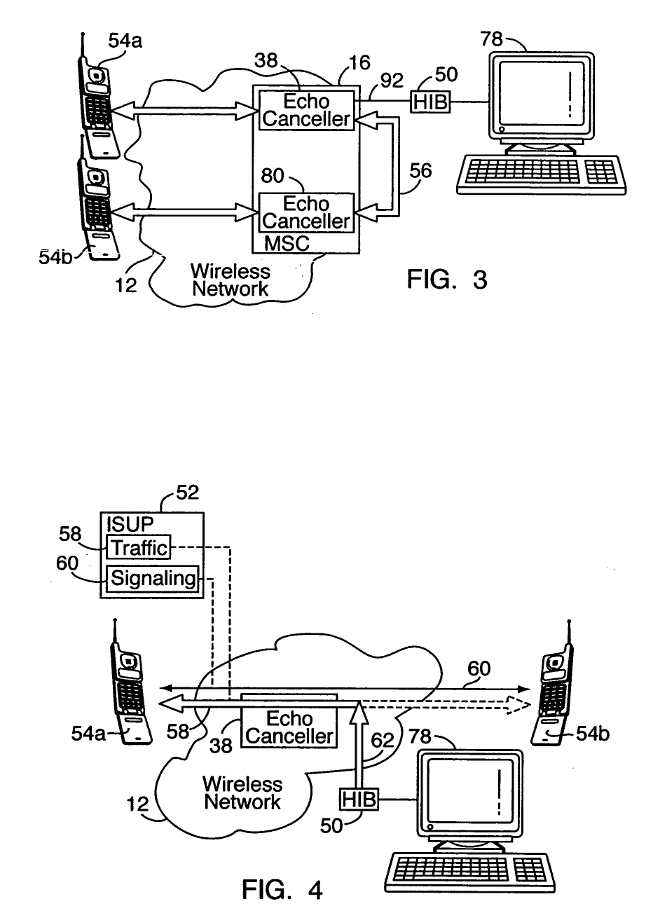

FIGS. 3-5 show an additional embodiment of the system applicable for “universal” testing of an embedded echo canceller 38. In other words, the echo canceller 38 may be tested with respect to a number of different hybrid circuits 32 for determining compliance with standards such as G.168-2000. (G.168-2000 is a specification setting forth various echo canceller performance standards for operation with seven of the most popular or typically encountered hybrid circuits 32.) From a conceptual standpoint, for testing in this manner the operational signals of the hybrid circuits of interest are generated and “injected” into the echo canceller, as it operates in an ongoing and normal manner, to simulate the actual presence of the hybrid circuits and their interaction with the echo canceller. As should be appreciated, testing in this manner is more accurate than laboratory mathematical simulations, and it is neither necessary to remove the echo canceller from the base station nor to swap out or otherwise provide the actual hybrid circuits.

For testing purposes, a hybrid interface box 50 (“HIB”) is attached to an upstream end of the echo canceller 38, possibly through a DSX panel 72, in a manner as further explained below. The hybrid interface box 50 is an electronics device that acts as a connection interface between the DSX panel 72 (or MSC or echo canceller) and a computer unit 78 running one or more echo canceller test programs. The HIB 50 may act solely in a connection interface capacity, or it may contain various electronics components such as configurable digital signal processors for simulating the operation of one or more hybrid circuits under the control of the echo canceller test programs. In other words, the echo canceller test programs and hybrid interface box work in a complementary and coordinated manner for simulating hybrid circuits, including the generation of delay, gain/loss, filters, and external signals for double-talk. The computer unit 78 may be a standard laptop computer or other microprocessor based unit. A suitable hybrid interface box 50 and suitable echo canceller test programs may be obtained from GL Communications Inc. of Gaithersburg, Md. (www.gl.com). For example, the hybrid interface box 50 may be the GL Communications “Laptop Portable USB T1/E1 Analyzer” operating under the control of the GL Communications “Manual Test Suite” for testing compliance of echo cancellers with G.168.

Once the HIB 50 and computer unit 78 are connected to the DSX panel 72, an ISUP communication or trunk 52 is established from a first wireless unit 54a to a second wireless unit 54b through the echo canceller 38 and a loop around trunk 56. “ISUP” is the ISDN User Part, a communications protocol used to setup, manage, and release trunk circuits that carry voice and data between parties in a communication network. The ISUP protocol specifies separate traffic and signaling/control channels 58, 60, as opposed to using in-band signaling. In other words, in an ISUP communication 52 there is a separate traffic channel 58 and a separate signaling channel 60. Control signals are not embedded or otherwise transmitted in the traffic channel. The ISUP communication 52 may be grown (established) by specifying the use of ISUP in a wireless unit subscriber form. To elaborate, when establishing a communication/link from one wireless unit to another, it is possible for many different types of communications to be grown, depending on the configuration of the network 12. Thus, it is typically possible for the user to designate which type of communication is to be established by way of a wireless unit subscriber form. When the user initiates a communication (e.g., by activating the wireless unit and entering a phone number), the wireless network accesses the form, identifies which type of communication the user has designated, and automatically grows the requested type of communication in a standard manner. As should be appreciated, instead of an ISUP communication, another type of communication having separate traffic and signaling channels may be used, depending on the type and configuration of the network and the components therein.

As noted, the communication 52 is established or routed through the loop around trunk 56. The loop around trunk 56 is a line or channel used to route a communication through the same switch. In other words, where a wireless unit-to-landline phone communication would route the communication out of the MSC 16 and to the PSTN 14, with a loop around trunk a wireless-to-wireless communication is routed “out and back” through the same MSC 16. As shown in FIG. 3, for example, the loop around trunk may comprise a jumper or set of jumpers directly or indirectly interconnecting the first echo canceller 38 and a second echo canceller 80 in the same MSC 16. The use of a loop around trunk 56 ensures that the communication 52 is routed along a path allowing for access to the traffic channel portion 58 of the communication 52. It also facilitates tracing and identification of the communication. Further, the loop around trunk is a 4-wire trunk, ensuring that the communication does not encounter a 4-wire/2-wire junction or the like. Ensuring that the communication is routed through a loop around trunk may be done in one of several ways, depending on the configuration of the network 12 and/or MSC(s) 16. For example, a loop around trunk may be specified in a wireless unit subscriber form, or a signaling command may be initiated at the wireless unit 54a. Alternatively, and more typically, the two wireless units 54a, 54b may be positioned in the network so that a communication between the two is automatically routed through a loop around trunk. For example, if two wireless units are in primary communication with the same base station, or in communication with separate base stations both connected to the same MSC 16, it may be the case that a communication established between the two is automatically routed though a loop around trunk. (The MSC is provided with a number of loop around trunks as part of its standard equipment or configuration for this purpose.) This is because the two wireless units 54a, 54b are effectively connected to the same switch. As should be appreciated, the point of a loop around trunk is to avoid the need for a communication originating and terminating at the same switch to be routed outside the switch.

Once the ISUP communication 52 is established, the communication is traced in a standard manner. In effect, the trace is carried out to identify the communication 52. For example, in some networks or MSC's different communications are routed through the same ports 82 and loop around trunk 56 in a time-multiplexed manner. In such a case, the trace is used to identify the time slot of the desired communication. Alternatively, the communication may be automatically randomly assigned to a dedicated loop around trunk and associated ports 80. In such a case, the trace is used to identify the MSC ports 82 (accessible by way of the DSX panel 72) through which the communication is being routed by the MSC. If the exact path or timing of the communication is known and/or pre-established, it may not be necessary to carry out the trace operation.

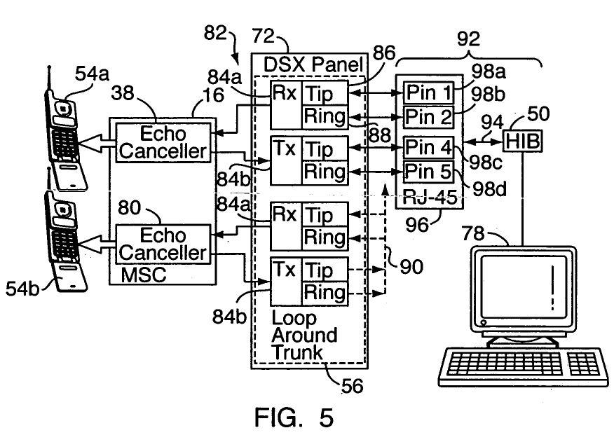

If it is necessary to identify the particular ports and/or loop around trunk through which the communication 52 is routed, the HIB 50 may be attached to the DSX panel 72 at that time. Otherwise, if the ports are known, the HIB 50 may be attached ahead of time, e.g., in parallel to the existing connection of the loop around trunk. FIG. 5 shows the loop around connection in more detail, as well as one example of how the HIB 50 may be interfaced with the MSC 16 and echo canceller 38. For the loop around trunk, the inputs and outputs of each echo canceller 38, 80 are connected to a reception (“Rx”) port 84a and transmission (“Tx”) port 84b, respectively. Each port is a 2-line (e.g., twisted pair) port. Thus, each port 84a, 84b includes a “ring” connection 86 and a “tip” connection 88. The ring connection is for the live or non-inverting line of the twisted pair, while the tip connection is for the ground or inverting line of the twisted pair. In combination, the Rx port 84a and Tx port 84b form a 4-wire trunk. For a loop around trunk, a 4-wire jumper 90 is run between the two sets of ports in a complementary manner, e.g., the Tx port of one echo canceller is connected to the Rx port of the other. An instrumented cable 92 is used to connect the HIB 50 and DSX panel 72. The instrumented cable 92 includes a 4-wire flat cable portion 94 terminated by an RJ-45 connector 96 or the like on one end and by a connector appropriate for connection to the HIB 50 at the other end. The RJ-45 includes eight pins, but only four are used here. In particular, four pins 98a-98d of the RJ-45 connector 96 are connected to the ports 84a, 84b associated with the first wireless unit 54a, in a manner as shown in FIG. 5. Other configurations are possible.

Referring to FIG. 4, once the communication 52 is established and traced, the audio path of the communication is terminated using the HIB 50. Thus, instead of routing voice, audio, or other data traffic signals from the first wireless unit 54a to the second wireless unit 54b over the traffic channel 58 of the ISUP communication 52, the traffic channel 58 to the second wireless unit 54b is broken and traffic signals are routed between the first wireless unit 54a and the HIB 50. Breaking the traffic channel 58 to the second wireless unit 54b may be accomplished by physically breaking the connection at the DSX panel, e.g., by removing or disconnecting the loop around trunk jumper or patch cable 90. If electronic or logical/signal control of the traffic channel to the second wireless unit 54b is possible, the traffic channel 58 may be electronically broken or terminated. In either event, breaking the traffic channel 58 does not result in termination of the communication 52. This is because the traffic channel 58 in the ISUP communication 52 is separate from the signaling channel 60—an interruption in the traffic channel does not affect the signal channel.

Once the traffic channel 58 is broken to the second wireless unit 54b, the traffic channel in effect resides between the first wireless unit 54a and the HIB 50 through the echo canceller 38. Subsequently, the echo canceller test programs on the computer unit 78 are used to control the HIB 50 for injecting test signals 62 into the traffic channel 58. For example, the HIB 50 and test programs may be configured to: i) read incoming traffic signals from the wireless unit 54a (e.g., transmitted over the Tx port 84b and received at the pins 98c, 98d); ii) generate a signal 44c simulating data traffic and/or the echo signal produced by a particular type of hybrid circuit (the echo signal would be based on the incoming traffic signal); and iii) transmit the signal 44c back over pins 98a, 98b for reception at the Rx port 84a. The test signals 62 are subsequently routed to and through the echo canceller 38, and the operation of the echo canceller 38 is measured as described above with reference to FIG. 2. The process may be repeated for different test signals 62 that simulate the types of signals generated by different hybrid circuits. Although the second wireless unit 34b is “left on” to maintain the communication 52 (e.g., for signaling purposes), it can otherwise be ignored.

Since certain changes may be made in the above-described method and system for testing an embedded echo canceller in a wireless network, without departing from the spirit and scope of the invention herein involved, it is intended that all of the subject matter of the above description or shown in the accompanying drawings shall be interpreted merely as examples illustrating the inventive concept herein and shall not be construed as limiting the invention.

We claim:

1. A method for testing an echo canceller in a wireless network, said method comprising the steps of:
routing at least one traffic signal through an embedded echo canceller; and
measuring at least one of an input signal and an output signal of the echo canceller, said at least one of the input signal and the output signal relating to operations by the echo canceller to remove at least one echo signal from the at least one traffic signal, wherein the echo signal is introduced by a hybrid unit.

2. The method of claim 1 wherein:
the hybrid unit comprises a hybrid interface box connected to the echo canceller and controlled by at least one echo canceller test program; and
at least one of said at least one echo signal and said at least one traffic signal comprises at least one test signal generated by the hybrid interface box.

3. The method of claim 2 wherein the at least one test signal comprises a plurality of test signals each simulating the operation of a different hybrid circuit.

4. The method of claim 2 further comprising:
measuring a plurality of input and output signals of the echo canceller, wherein the input and output signals are measured at a digital signal cross-connect panel connected between the echo canceller and the hybrid interface box and/or at a radio access interface of the echo canceller.

5. The method of claim 2 further comprising:
establishing an ISUP communication between a first wireless unit and a second wireless unit over the wireless network, wherein the communication is routed through the embedded echo canceller and a loop around trunk;
tracing the communication to identify a traffic channel portion of the communication; and
injecting the at least one test signal into the traffic channel.

6. The method of claim 5 wherein the at least one test signal comprises a plurality of test signals each simulating the operation of a different hybrid circuit.

7. The method of claim 6 further comprising:
measuring a plurality of input and output signals of the echo canceller, wherein the input and output signals are measured at a digital signal cross-connect panel connected between the echo canceller and the hybrid interface box and/or at a radio access interface of the echo canceller.

8. The method of claim 1 further comprising:
measuring a plurality of input and output signals of the echo canceller, wherein the input and output signals are measured at a digital signal cross-connect panel connected between the echo canceller and the hybrid interface box and/or at a radio access interface of the echo canceller.

9. The method of claim 1 further comprising:
measuring first and second input signals of the echo canceller, wherein the first input signal is a first traffic signal from a wireless unit, and wherein the second input signal includes a second traffic signal from the hybrid unit and the at least one echo signal; and
measuring a first output signal of the echo canceller, said first output signal comprising the second input signal as operated upon by the echo canceller to remove the at least one echo signal there from.

10. The method of claim 9 further comprising:
measuring the first traffic signal, wherein the first traffic signal is routed to the hybrid unit.

11. The method of claim 10 wherein the first input signal and the first output signal are measured at a radio access interface of the echo canceller.

12. The method of claim 11 wherein the second input signal and the first traffic signal are measured at a second input and a second output of the echo canceller, respectively, said second input and second output being connected to the hybrid unit.

13. The method of claim 12 wherein the second input signal and the first traffic signal are measured at a digital signal cross-connect panel connected to the second input and second output of the echo canceller.

14. A method for testing an embedded echo canceller in a wireless network, said method comprising the steps of:
establishing a communication between a first wireless unit and a second wireless unit through the embedded echo canceller and through a loop around trunk, wherein the communication includes separate signaling and traffic channels; and
measuring operation of the echo canceller on at least one test signal injected into the traffic channel portion of the communication.

15. The method of claim 14 further comprising:
generating said at least one test signal at a hybrid interface box connected to the echo canceller and controlled by at least one echo canceller test program, wherein the at least one test signal simulates the operation of at least one hybrid circuit.

16. The method of claim 15 further comprising:
tracing the communication to identify the traffic channel;
breaking the traffic channel to inject the at least one test signal; and
measuring a plurality of input and output signals of the echo canceller, wherein the input and output signals are measured at a digital signal cross-connect panel connected between the echo canceller and the hybrid interface box and/or at a radio access interface of the echo canceller.

17. The method of claim 16 wherein:
the communication is an ISUP communication; and
the traffic channel is broken by disconnecting the loop around trunk.

18. A method for testing an echo canceller in a wireless network, said method comprising the steps of:
injecting at least one test signal into a traffic channel portion of a communication routed through an embedded echo canceller, said communication including the traffic channel and a separate signaling channel, wherein the at least one test signal simulates the operation of at least one hybrid circuit; and
measuring operation of the echo canceller on said at least one test signal.

19. The method of claim 18 further comprising the steps of:
establishing the communication between a first wireless unit and a second wireless unit through a loop around trunk;
tracing the communication to identify the traffic channel; and
breaking the traffic channel to inject the at least one test signal, wherein the traffic channel is broken by disconnecting the loop around trunk.

20. The method of claim 19 further comprising:
generating the at least one test signal at a hybrid interface box connected to the echo canceller, said hybrid interface box being controlled by at least one echo canceller test program.
